(19) United States
(12) Patent Application Publication
(10) Pub. No.: US 2005/0117095 A1
(43) Pub. Date: Jun. 2, 2005

(54) Reflective cholesteric displays employing linear polarizer

(76) Inventor: Yao-Dong Ma, Frisco, TX (US)

Correspondence Address: Yao-Dong Ma, 14586 Pensham Dr., Frisco, TX, 75035, US

(21) Appl. No.: 10/727,296

(22) Filed: Dec. 2, 2003

(51) Int. Cl. G02F 1/1335

(52) U.S. Cl. 349/113; 349/115

(57) ABSTRACT

The present invention relates to cholesteric displays, and more specifically, to reflective cholesteric displays employing linear polarizer(s). Two display modes have been accomplished and both of them take on black-and-white appearances. The addition of the weak linear polarizer has greatly increased the brightness of the white color while maintaining the black darkness.

### FIELD OF INVENTION

The present invention relates to cholesteric displays, and more specifically, to reflective cholesteric displays employing linear polarizer(s). Two display modes have been accomplished and both of them take on black-and-white appearances. The addition of the weak linear polarizer has greatly increased the brightness of the white color while maintaining the black darkness.

### BACKGROUND OF THE INVENTION

Cholesteric liquid crystal displays are characterized by the fact that the pictures stay on the display even if the driving voltage is disconnected. The bistability and multistability also ensure a completely flicker-free static display and have the possibility of infinite multiplexing to create giant displays and/or ultra-high resolution displays. In cholesteric liquid crystals, the molecules are oriented in helices with a periodicity characteristic of material. In the planar state, the axis of this helix is perpendicular to the display plane. Light with a wavelength matching the pitch of the helix is reflected and the display appears bright. If an AC-voltage is applied, the structure of the liquid crystals changes from planar to focal conic texture. The focal conic state is predominately characterized by its highly diffused light scattering appearance caused by a distribution of small, birefringence domains, at the boundary between those domains the refractive index is abruptly changed. This texture has no single optic axis. The focal conic texture is typically milky-white (i.e., white light scattering). Both planar texture and focal conic texture can coexist in the same panel or entity. This is a very important property for display applications, whereby the gray scale can be realized.

Current cholesterics displays are utilizing “Bragg reflection”, one of the intrinsic properties of cholesterics. In Bragg reflection, only a portion of the incident light with the same handedness of circular polarization and also within the specific wave band can reflect back to the viewer, which generates a monochrome display. The remaining spectrum of the incoming light, however, including the 50% opposite handedness circular polarized and out of Bragg reflection wave band, will pass through the display and be absorbed by the black coating material on the back surface of the display to ensure the contrast ratio. The overall light utilization efficiency is rather low and it is not qualified in some applications, such as a billboard at normal ambient lighting condition. The Bragg type reflection gives an impression that monochrome display is one of the distinctive properties of the ChLCD.

U.S. Pat. No. 3,704,056 introduces a transmissive display in a way of attaching two linear polarizers between a cholesteric cell structure to enhance the contrast between the image and the background area. The liquid crystalline material is designed in an infrared waveband. A back lighting source is projected on the display screen so that an image will take on the dark background. Since the two polarizers are arranged crossed to each other, the display takes on black state in Grandjean (planar) texture area and white state in focal conic texture area respectively. Unfortunately, such a display mode has been greatly limited its applications in nowadays portable electronic devises.

U.S. Pat. No. 5,796,454 introduces a black-and-white back-lit ChLC display. It includes controllable ChLC structure, the first circular polarizer laminating to the first substrate of the cell which has the same circular polarity as the liquid crystals, the second circular polarizer laminating to the second substrate of the cell which has a circular polarity opposite to the liquid crystals, and a light source. The display is preferably illuminated by a light source that produces natural “white” light. Thus, when the display is illuminated by the back light, the circular polarizer transmits the 50% component of the incident light that is right-circularly polarized. When the ChLC is in an ON state, the light reflected by the ChLC is that portion of the incident light having wavelengths within the intrinsic spectral bandwidth, and the same handedness; The light that is transmitted through the ChLC is the complement of the intrinsic color of ChLC. Since the transmitted light has right-circular polarization, it will be blocked by the left-circular polarizer. Therefore, this area will be substantially black. When the display is in an OFF state, the light transmitted through the polarizer is optically scattered by the ChLC in focal conic structure. The portion of the incident light that is forward-scattered is emitted from the controllable ChLC structure as depolarized light. The left-circularly polarized portion of the forward-scattered light is then transmitted through the left-circular polarizer, and finally is perceived by an observer. Such black-and-white effect is achieved by the back-lit component and the ambient light is nothing but noise.

U.S. Pat. No. 6,344,887 introduces a method of manufacturing a full spectrum reflective cholesteric display, herein is incorporated by reference. '887 teaches a cholesteric display employing absorptive polarizers with the same polarity but different disposition. The display utilizes an absorptive circular polarizer and a metal reflector film positioned on the backside of the display to guide the second component of the incoming light back to the viewer. However, the shortcoming of the Iodine type absorptive polarizer makes the display to take on a tint of color in the optical ON state, for example, greenish white. The reasons for that are described as follows: Firstly, all the absorptive iodine polarizer has a more or less blue leaking problem which causes non-neutral color of a display device. Secondly, the absorptive polarizer has limited transmission (44%) and polarizing efficiency that causes the second reflection having less intensity than that of the first one. Thirdly, the metal reflector always has a limited reflectivity. Take the Aluminum for example, the reflectivity is in the range of 80-90%. Fourthly, the quarter waveform retardation film can only match a narrow wavelength of the light to generate a circularly polarized light. Addition to the multi-layer surface mismatching, the total reflection of the back absorptive circular polarizer is around 35%. All those reasons result in a full spectrum cholesteric display appearing non-paper white.

### SUMMARY OF THE INVENTION

It is the primary objective of the present invention to realize a reflective cholesteric display with high brightness.

It is another objective of the present invention to utilize linear polarizer(s) to modulate the optically homogeneous cholesteric liquid crystal structure.

It is still another objective of the present invention to use a weak linear polarizer to achieve a paper white reflection in display's focal conic texture.

It is also another objective of the present invention to create a black dark state in display's planar texture.

It is again another objective of the present invention to obtain black dark state by multiple pass absorption of the linear polarizers in display's focal conic texture.

It is still another objective of the present invention to use the optical homogeneous characteristics of the liquid crystal and the linear polarizers' modulation to achieve paper white state in displays' planar texture.

It is also another objective of the present invention to generate black-and-white display by means of the linear polarizer.

It is again another objective of the present invention to generate a full color display by means of the linear polarizer and the micro color filters.

It is a further objective of the present invention to realize a cholesteric display with a ultra low driving voltage.

### THEORETICAL BACKGROUND OF THE INVENTION

It is discovered that when the cholesteric liquid crystal material is tuned to a suitable helical pitch and when the display cell structure is satisfied with certain conditions such as the ratio of the cell thickness to the pitch (d/p), an in plane homogeneous cholesteric display can be formed. Such a homo-optical cholesteric phase has no visible color dispersion, no circularly polarization and retardation to the incident light so that a linear polarizer can be adapted to produce both reflective and transmissive display with black and white characteristics. Color filter can be also adopted to the cell structure to produce a full color display. The display will maintain its merits of long time memory at zero electric field, high information content or resolution, and so on.

The cholesteric liquid crystal display has two essential controllable structures, cholesteric planar structure and focal conic structure.

The planar structure in the present invention is an optically homogeneous structure for the purpose of ultra-high contrast ratio. The structure has less molecular disclination or the defect of liquid crystal orientation and less optical disturbance to the incoming light. Therefore, the application of such planar structure in transmissive display mode will endow the display with high transmittance (bright) when two linear polarizers attached in parallel to the display cell structure, and with high extinction (dark) when two crossed polarizers attached to the display respectively. There is also other reflective display mode wherein a linear polarizer attached to the front substrate and a reflective half-wave plate to the back substrate, the display will take on black dark state. The optical performance of the optically homogeneous structure is similar to the TN structure besides its much stronger twisting power. The pitch of the cholesteric structure is chosen in such a way that the Bragg reflection wave band is out of the visible wavelength so that there is no visible light discerned in the normal direction but a dull red color might be noticed in the oblique direction. Meanwhile the cell thick-to-pitch ratio (d/p) has been chosen in the range of 5-7, which endows the cholesteric material with a strong twisting angle, at least 1,800 degrees or 10π. Such a large twisting power ensures long time display memory when the power is off.

The focal conic structure of the new display structure is the same as traditional cholesteric displays. It is well known that the focal conic structure can be long-term stored in power off state as long as the twisting power is large enough. The shortcoming of short focal-conic storage time in the early days displays, from few seconds to a couple of hours as reported in 1970s and 1980s, is attributed to the low twisting power caused by an insufficient helical pitch and the ratio d/p. Optically, the focal conic structure is a multi-domain structure. One of the major features is light scattering and light depolarization. The strong scattering effect to the incoming light is due to the abrupt change of indices of refraction among cholesteric domains within the structure. The intensity of the light scattering (sometimes it is also called hiding power) depends on the optical birefringence of the liquid crystal, i.e. delta n, cell thickness and surface condition. The focal conic structure takes on a pure white color because of its optically symmetrical distribution. Similar to the homo-optical performances of cholesteric planar structure mentioned above, the focal conic structure is also optically homogeneous. There is no coloration, polarization or retardation to the incoming light.

The above-mentioned in plane homogeneous properties of both cholesteric planar texture and focal conic texture give a birth to a new category of reflective black-and-white displays by means of linear polarizing modulations. Basically, there are two display modes introduced in the present invention. Firstly, planar texture as the white color state and the focal conic texture as the black state; Secondly, planar texture as the black state while the focal conic texture as the white color state. The former display mode takes the advantage of the two linear polarizers' light-guiding effect in the planar texture and the light multi-pass-absorption effect in the focal conic texture. The latter mode utilizes a linear polarizer and a reflective half-wave plate to obtain a black planar texture and white focal conic texture.

Another main advantage of the present invention is the low driving voltage. Since the helical pitch of cholesteric liquid crystals is chosen in the near-infrared wavelength, the working voltage is much lower than that of the prior art. The phase change voltage in the present invention, for example, is only 12 volts and the phase transition voltage from planar to focal-conic is 3.5 volts.

### BRIEF DESCRIPTION OF THE DRAWINGS

FIG. 1 demonstrates a schematic sectional structure of a reflective black-and-white display with a weak absorptive linear polarizer attached onto the front substrate of the display cell, and a reflective half wave plate on the back substrate of the display cell.

FIG. 2 demonstrates a schematic sectional structure of a reflective black-and-white display attached with two crossed linear polarizers and a metal reflector.

FIG. 3 demonstrates a schematic sectional structure of a reflective black-and-white display attached with a front absorptive linear polarizer and back reflective linear polarizer.

FIG. 4 demonstrates a schematic sectional structure of a reflective full color display with an absorptive color filter deposit inside the display cell. An absorptive linear polarizer and a reflective half wave plate are also attached to the outside of the cell respectively.

FIG. 5 demonstrates a schematic sectional structure of a reflective black-and-white display attached with two in-parallel linear polarizers and a metal reflector.

### DETAILED DESCRIPTION

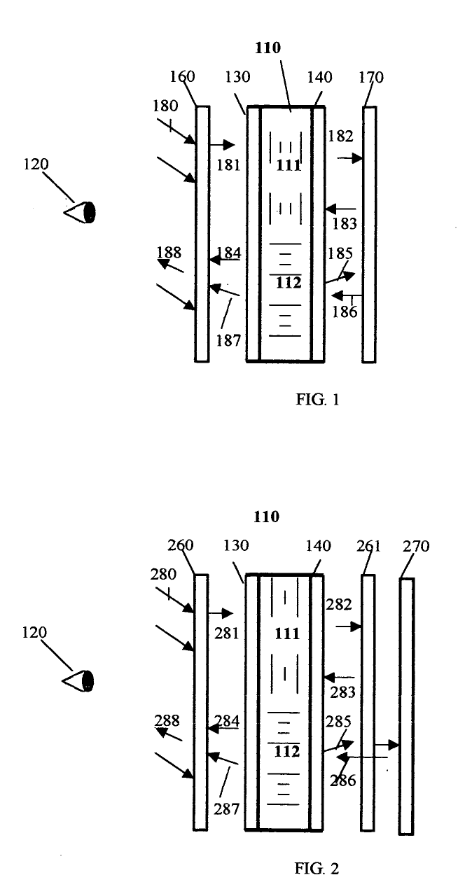

Referring first to FIG. 1 illustrated is the reflective cholesteric display modulated by a front linear polarizer, a reflective half-wave plate. The natural light 180 reaches the front linear polarizer 160 that is laminated on the first display substrate 130. A portion of incoming light is filtrated by the polarizer and remaining polarizing light 181 is allowed to pass. When 181 passes the cholesteric film 110 in the planar structure 111 wherein the helical pitch has tuned in IR wavelength, there will be no visible circularly polarization generated. Thus the out-coming light 182 will substantially remain its linear polarization state. The linear polarization 182 then hits on a reflective half wave plate 170, which turns the incoming light into orthogonal polarization 183. As the light 183 traveling through planar structure 111, it remains the same polarization state because the media is in-plane homogeneous. Since light 183 is orthogonal to 182, it will be substantially cut off by the front polarizer 160. As a result, a black optical state will be displayed in the planar texture area.

There are three physical matters need to be satisfied with to ensure the optical dark state. Firstly, the selective reflection of circularly polarization must be out-off visible wave bend. The intrinsic Bragg reflection should either in the IR wave bend or in the UV wave bend. The former is more preferable because it has lower driving voltage and faster response time. The helical pitch of the cholesteric molecules, determined by the formula:
λ=n P>700 nm
where “λ” represent the wavelength of the intrinsic Bragg reflection, “n” the average refractive index of the liquid crystal and “P” the helical pitch of the liquid crystal. Therefore, the pitch should be adjusted to over 0.50 μm, or more preferably, in the range of 0.50-0.80 μm.

Secondly, the frond linear polarizer 160 and the back reflective half plate 170 should be aligned in approximately 45 degrees to achieve 90-degree optical phase change, i.e., “e” component polarization (input) becomes “o” component polarization (output), or vice versa. The letter “e” means the extraordinary component of the incoming light and “o” the ordinary component of it.

Thirdly, the planar structure should design to be substantially single domain structure, which rules out the possibility of depolarization effect due to abruptly changing of the refractive indices among the edges of the domains. Double rubbing or single rubbing the alignment layer(s), deposited on the inner surfaces of display substrates, will be able to realize the required structure. Double surface rubbing is preferred if it were not consider other parameters because of the short relaxation time and uniform domain configuration. As a matter of fact, single rubbing usually gives more balanced performances.

On the other hand, cholesteric focal conic structure 112 is multi-domain structure. The natural light 180 first reaches the front linear polarizer 160 that is laminated on the first display substrate 130. A portion of the incoming light is filtrated by the polarizer and remaining polarizing light 181 is allowed to pass through the linear polarizer. When 181 passes the cholesteric film 110 in the focal conic structure 112 it will be depolarized by the scattering effect due to abruptly changing of the refractive indices among the domain edges of domains. The depolarized light will split into two parts, forward scattering 185 and backward scattering 184. The forward scattered light 185 then hit on the reflective half wave plate and is bounced back (see light 186). The light 186 further passes through focal conic 112 and becomes light 187. Finally the backward scattering 184 joins with 187, passing through front polarizer, and emerges to the front of the display as the polarized light 188, which will be discerned by the viewer. Indeed, the light out of the cholesteric focal conic structure is white light. Perhaps the most important discovery of the present invention is that the white light reflection in the focal conic area can be as high as 50% of the total incoming light while the contrast ratio is maintaining at a high level. A weak linear polarizer and a specula reflective component attributes to the valuable performance. There are two types of linear polarizers have been used in the present invention. The first one is NITTO NPF-F1228DU, made in Japan, with the following properties:

TABLE 1

| TRANSMITTANCE (%) | | | |
|---|---|---|---|
| Single | Parallel | Crossed | EFFICIENCY (%) |
| 48.2 | 40.7 | 6.7 | 84.7 |

The polarizer gives out a good display parameters including whiteness in the focal conic area and the darkness in the planar texture area.

To further improve the whiteness, a weak linear polarizer has been utilized. The weak polarizer can be also called a partial polarizer which means that when a light beam passing the film only partial of it is being polarized and majority part of it will remain the original state. The parameter of the weak polarizer is listed as following:

TABLE 2

| | Transmittance | | | | Efficiency | Dichroic |
|---|---|---|---|---|---|---|
| | (%) | L | a* | b* | (%) | ratio |
| Single | 66.3 | 85.3 | −1.0 | 3.2 | 32.089 | 6.011 |
| Parallel | 49.2 | 75.8 | −0.3 | 5.4 | | |
| Cross | 39.999 | 69.6 | −1.5 | 8.6 | | |

Surprisingly, the unique weak linear polarizer turns out an unexpected result. The brightness of the neutral white optical state is found to be better than a newspaper when the applicant made an apple-to-apple comparison with a sheet of newspaper. It is also found that the blackness of the display in optical “off” state is still satisfactory in the planar texture area within a wide viewing cone. The adoption of the weak linear polarizer produces not only the paper white brightness in focal conic texture but also the darkness in the planar texture with the help of the specula reflective component. Since the reflective half wave plate is of a specula reflector, it is capable of reflecting the light in a very narrow angle determined by the reflection law. Plus the reflection is not being disturbed in the planar texture area because of the homogeneity in the X-Y plane. Furthermore, the mirror reflected light has the same emergent angle as the display's surface reflection so that the viewer always tends to avoid this viewing direction subconsciously as watching the display. A visual testing has carried out and the result is very promising. The display in planar state really takes on a black dark “off” state over a large viewing angel, despite the fact that there is a light leaking in the specula direction. By the way, in order to maintain long-term-stable state for both planar and focal conic structures, it is required that an optimal cell parameter, thick-to-pitch ratio, i.e. d/P ratio be in the range of 5˜7. The letter “d” represents the cell thickness and “P”, the pitch of liquid crystal.

The weak linear polarizer combined with a specula reflective half wave plate structure, as mentioned above, preduces a high brightness, high contrast and pure black-and-white cholesteric display. Under a suitable driving waveform, both the planar and focal conic structure, at least a portion of them, are interchangeable and long term stable.

Turning now to FIG. 2 illustrated is the reflective cholesteric display modulated by a front linear polarizer 260, a back polarizer 261 and a specula mirror reflector 270. When the light 280 passes the front linear polarizer 260, half of it will be cut off. As the remaining polarizing light 281 reaches the display cell 110 in the planar structure 111, there will be no visible circularly polarization generated. Thus the out-coming light 282 will substantially remain its linear polarization. The light 282 then passes through the back polarizer 261 and is totally absorbed. As a result, a black optical state will take on in the planar texture area.

When the front light 280 passes the front linear polarizer 260, half of it will be cut off. As the remaining polarizing light 281 reaches the display cell 110 in the focal conic structure 112 it will be depolarized by the scattering effect due to abruptly changing of the refractive indices among edges of domains. The depolarized light will split into two parts, forward scattering 285 and backward scattering 284. The forward neutral non-polarized light 285 then passes back through linear polarizer 261 and becomes linear polarization 286 which then is bounced back by mirror reflector 270 and again through the linear polarizer 261 and maintains its linear polarization 286. The light 286 then passes through focal conic 112 and becomes a depolarized light 287. Finally the backward scattering 284 joins with 287 through polarizer 260 and emerges to the front as the polarized light 288. Indeed, the light 288 out of the cholesteric focal conic structure is white light.

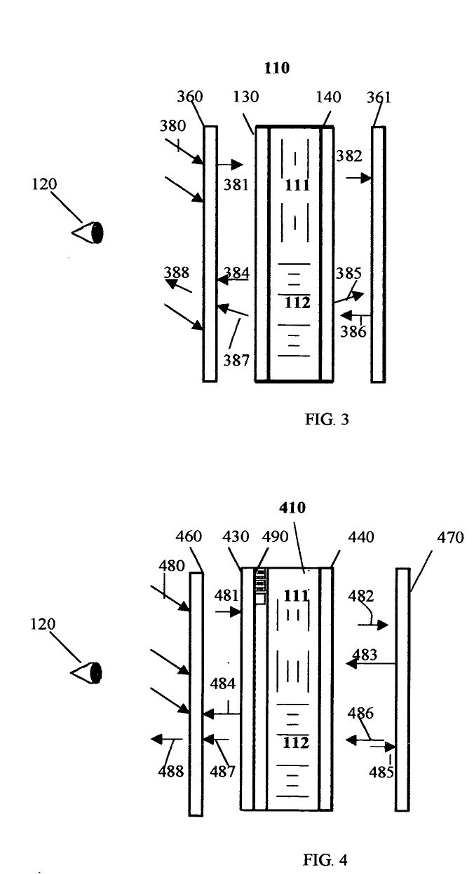

Turning now to FIG. 3 illustrated is the reflective cholesteric display modulated by a front linear polarizer 360, a back reflective polarizer 361. Two polarizers are aligned with their absorption axis across to each other. When the light 380 passes the front linear polarizer 360, half of it will be cut off. As the remaining polarizing light 381 reaches the display cell 110 in the planar structure 111, there will be no visible circularly polarization generated. Thus the out-coming light 382 will substantially remain its linear polarization. The light 382 then passes through the back polarizer 361 and is totally absorbed by a black coating of the polarizer. As a result “black” state will take on the planar structure area.

When the front light 380 passes through the front linear polarizer 360, half of it will be cut off. As the remaining polarizing light reaches the cholesteric film 110 in the focal conic structure 112, it will be depolarized by the scattering effect due to abruptly change of the refractive indices among edges of domains. The depolarized light will split into two parts, forward scattering 385 and backward scattering 384. The forward neutral non-polarized light 385 then hits on the back reflective linear polarizer 361 and 50% of it becomes linear polarization 386. The light 386 then passes through focal conic 112 and becomes a depolarized light 387. Finally, the backward scattering 384 joining with 387 through the front polarizer and converts into polarized light 388, which is discerned by the viewer. Indeed, the light 388 out of the cholesteric focal conic structure is white light.

The reflective mode display of the present invention has high brightness. Instead of absorptive back linear polarizer as described in FIG. 2, the current structure adopts a reflective polarizer. For example, a reflective linear polarizer RDF-B produced in 3M Optical Systems Division is able to reflect one component of polarization and absorb the other component. The RDF (reflective display film) is made of multi-layer lamination structure of two polymer films with the thickness of 0.122 mm. Each polymer film has a different reflective index and a predetermined thickness so that the interfacial reflections between the multiple layers construct a reflective linear polarization in the direction of reflection axis while the other polarization will be pass through the multi-layer structure in transmission axis. The transmissive component is then absorbed by the underneath black coating layer. Practically, the total reflection in focal conic texture will be approximately 50%, the same reflection as an ordinary newspaper.

Turning now to FIG. 4, illustrated is a front color filter positioned inside of the display cell, a front linear polarizer and a reflective half wave plate are laminated to the outside of the display cell respectively. A color filter layer 490, including red, green and blue patterning, is deposited on the front substrate 430. The natural light 480 reaches the front linear polarizer 460 that is laminated on the first display substrate 430. Approximately 50% of incoming light is filtrated by the polarizer and remaining polarizing light 481 is allowed to pass through the linear polarizer. When the polarizing light 481 passes through the front color filter layer 490, the absorptive coloring material will attenuate it initially. The remaining portion will then reach to the cholesteric film 110 in planar texture area 111 wherein the helical pitch has tuned in the IR wavelength, there will be no visible circularly polarization generated. Thus the out-coming light 482 will substantially remain its linear polarization state. The linear polarization 482 then hits on a reflective half wave plate, which turns the incoming light into orthogonal polarization 483. As the light 483 traveling through planar structure 111, it remains the same polarization state because the media is in-plane homogeneous. Since light 483 is orthogonal to 482, it will be completely cut off by the front polarizer 460. As a result, a black optical state will be displayed in the planar texture area.

On the other hand, cholesteric focal conic structure 112 is multi-domain structure. The natural light 480 first reaches the front linear polarizer 460 that is laminated on the first display substrate 430. A portion of incoming light is filtrated by the polarizer and remaining polarizing light 481 is allowed to pass through the linear polarizer. The polarizing light 481 further passes the color filter layer and then the cholesteric film 110 in the focal conic structure 112 and it becomes depolarized color light depending on the imagewise focal conic patterning. The depolarized light will split into two parts, forward scattering 485 and backward scattering 484. The forward scattered light 485 then hit on the reflective half wave plate and is bounced back (see light 486). The light 486 further passes through focal conic 112 and becomes light 487. Finally it joins with the backward scattering 484, passing through the color filter layer and front polarizer, and emerges to the front of the display as the color light 488, which will be discerned by the viewer. Indeed, the light out of the cholesteric focal conic structure is color light with a predetermined tint.

Above all, with the full color optical ON state in focal conic area and the dark optical OFF state in planar area, the present invention achieves a full color reflective display with black background.

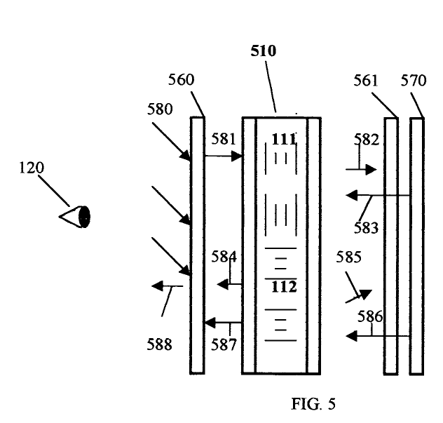

Turning now to FIG. 5, illustrated is a black-and-white cholesteric display structure of two in-parallel linear polarizers combined with a metal reflector. When the natural light 580 first reaches the first linear polarizer 560, 50% of it is filtrated by the polarizer and other 50%, as the light 581, is allowed to pass. The remaining component then passes the in-plane homogeneous ChLC film without substantial attenuation. The component 581, passing through the second linear polarizer 561 without attenuation, is reflected by a metal reflector (see light 583). Furthermore, the light 583 is guided to pass all the way through the second polarizer, ChLC film and the first polarizer without substantially optical loss and finally emerges to the display front surface 588. In this way, a pure white color will be displayed on the planar texture area.

As the ChLC domains addressed in a focal conic structure 112 the display works at optical “off” state. When the incident light 580 passes through the first polarizer 560, it will be cut more than 50%. The rest 581 will get to the ChLC cell with focal conic texture and be depolarized by the scattering effect of the LC material. The neutral non-polarized light 585 then passes the second linear polarizer 561, becomes linear polarized light 586 at the cost of 50% light being cut off. The linear polarized light is then reflected by the aluminum thin layer 570 and passes the ChLC cell again where becoming depolarized light 587 due to the focal conic scattering effect. Similarly, when the non-polarized remaining light passes the first polarizer, half of it will be absorbed. Finally, only a small portion of the total incident light has a chance to reach the front as a linear polarized light. As a result, the specially designed multiple-pass-absorption creates the optical dark state in the focal conic texture area.

1. A reflective display comprising:
a. a linear polarizer,
b. a reflective half-wave plate,
c. a plurality of transparent conductive patterned substrates juxtaposed to form a cell structure,
d. a cholesteric material with a predetermined reflective wavelength and a predetermined thick-to-pitch ratio and with at least one controllable optical ON texture and at least one controllable optical OFF texture respectively,
wherein the cell structure enclosing the cholesteric material, attaching the linear polarizer on the front outside surface and the reflective half-wave plate on the back outside surface,
whereby a paper white state will be displayed in the controllable optical ON texture area; and a black state will be displayed in the controllable optical OFF texture area.

2. The reflective display as in claim 1 wherein the paper white ON state is the controllable focal conic state.

3. The reflective display as in claim 1 wherein the black optical OFF state is the controllable planar state.

4. The reflective display as in claim 1 wherein the black optical OFF state is the controllable field-induced nematic state.

5. The reflective display as in claim 1 wherein the reflective half-wave plate is a specula 180° phase shifter.

6. The reflective display as in claim 1 wherein the predetermined reflective wavelength is in near infrared wave band.

7. The reflective display as in claim 1 wherein the predetermined thick-to-pitch ratio is 5˜10.

8. The reflective display as in claim 1 wherein the linear polarizer is a weak linear polarizer with single transmittance at least 60% and polarization efficiency at least 30%.

9. The reflective display as in claim 1 further including a color filter layer positioned inside of the cell substrate to achieve a reflective full color display.

10. A reflective display comprising:
a. an absorptive linear polarizer
b. a reflective linear polarizer with crossed polarity to the absorptive linear polarizer,
c. a plurality of transparent conductive patterned substrates juxtaposed to form a cell structure,
d. a cholesteric material with a predetermined reflective wavelength and a predetermined thick-to-pitch ratio and with at least one controllable optical ON texture and at least one controllable optical OFF texture respectively,
wherein the cell structure enclosing the cholesteric material, attaching the absorptive polarizer on the front outside surface and the reflective linear polarizer on the back outside surface,
whereby a paper white state will be displayed in the controllable optical ON texture area; and a black state will be displayed in the controllable optical OFF texture area.

11. The reflective display as in claim 10 wherein the transmissive optical ON state is the controllable focal conic state.

12. The reflective display as in claim 10 wherein the optical OFF state is the controllable planar state.

13. The reflective display as in claim 10 wherein the optical OFF state is the controllable field-induced nematic state.

14. The reflective display as in claim 10 wherein the reflective linear polarizer is a composite structure of a non-absorptive linear polarizer and an absorptive layer.

15. The reflective display as in claim 10 wherein the reflective linear polarizer is a composite structure of an absorptive linear polarizer and a metal reflector.

16. A reflective display comprising:
a. an absorptive linear polarizer
b. a reflective linear polarizer with in-parallel polarity to the absorptive linear polarizer,
c. a plurality of transparent conductive patterned substrates juxtaposed to form a cell structure,
d. a cholesteric material with a predetermined reflective wavelength and a predetermined thick to pitch ratio and with at least one controllable optical ON texture and at least one controllable OFF texture respectively,
wherein the cell structure enclosing the cholesteric material, attaching the absorptive polarizer on the front outside surface and the reflective linear polarizer on the back outside surface,
whereby a paper white state will be displayed in the controllable optical ON texture area due to the guiding effect of the linear polarizers; and a black state will be displayed in the controllable optical OFF texture area due to the multi-pass absorption effect of the linear polarizers.

17. The reflective display as in claim 16 wherein the optical ON state is the controllable planar state.

18. The reflective display as in claim 16 wherein the optical ON state is the controllable field-induced nematic state.

19. The reflective display as in claim 16 wherein the optical OFF state is the controllable focal conic state.

20. The reflective display as in claim 16 wherein the reflective linear polarizer is a composite structure of a non-absorptive linear polarizer and an absorptive layer.
